(19) United States
(12) Patent Application Publication
(10) Pub. No.: US 2025/0163795 A1
(43) Pub. Date: May 22, 2025

(54) PERSONNEL DETECTION SYSTEM FOR A DRILLING SITE

(71) Applicant: Helmerich & Payne Technologies, LLC, Tulsa, OK (US)

(72) Inventors: Richard KULAVIK, Frisco, TX (US); Jason Truman RICE, Plano, TX (US)

(21) Appl. No.: 18/948,810

(22) Filed: Nov. 15, 2024

Related U.S. Application Data
(60) Provisional application No. 63/600,163, filed on Nov. 17, 2023.

(51) Int. Cl. E21B 44/00; G08B 21/02

(52) U.S. Cl. CPC E21B 44/00; G08B 21/02

(57) ABSTRACT

A computer vision system and method may be used with a drilling site for management and safe operation of equipment associated with oilfield operations. The system and method may identify a person based on a detection of a head and a body of the person. In some embodiments, the system identifies a one or more control zones and implements one or more safety control responses based on a detection of the person in one of the one or more control zones. In certain cases, the system may maintain the one or more safety control responses until the person exits the one or more control zones.

### CROSS-REFERENCES TO RELATED APPLICATIONS

This application claims the benefit of and priority to U.S. Provisional Application No. 63/600,163, filed Nov. 17, 2023, entitled “PERSONNEL DETECTION SYSTEM FOR A DRILLING SITE”, the disclosure of which is hereby incorporated by reference in its entirety.

### FIELD OF THE INVENTION

This application relates to systems and methods for oilfield drilling operations, and more particularly to systems and methods relating to health, safety, personnel detection, and related operational matters at a drilling site.

### BACKGROUND

Drilling a borehole for the extraction of minerals has become an increasingly complicated operation due to the increased depth and complexity of many boreholes, including the complexity added by directional drilling. Drilling is an expensive operation and errors in drilling add to the cost and, in some cases, drilling errors may permanently lower the output of a well for years into the future. Many systems exist for improving some aspects of drilling operations, including through enhanced management of various aspects of drilling operations, such as is disclosed in U.S. patent application Ser. No. 14/314,697, entitled “System and Method for Surface Steerable Drilling” (patented as U.S. Pat. No. 9,494,030) (“'030 Patent”), U.S. patent application Ser. No. 15/196,242, entitled “System and Method for Detection of Slide and Rotation Modes” (published as US 2016/0305230 A1) (“'230 Publication”), U.S. Provisional Patent Application 62/619,242, entitled “System and Method for Managing Drilling Mud and Additives” (“'242 Application”), and U.S. Provisional Patent Application 62/689,631, entitled “System and Method for Well Drilling Control Based on Borehole Cleaning” (“'631 Application”), all of which are incorporated by reference for all purposes as if fully set forth herein.

Drilling is also a complex operation involving heavy equipment operating in close proximity to drilling personnel and can therefore also be a dangerous operation if not planned and performed for safety. Drilling personnel not only operate equipment remotely, but often manually perform operations, such as removing drilling slips, or screwing/unscrewing various components and pipes from the drill string. Example drilling procedures and personnel are described in, for example, U.S. Pat. No. 8,210,283, issued on Jul. 3, 2012, and entitled “System and Method for Surface Steerable Drilling,” which is incorporated by reference for all purposes as if fully set forth herein. Current technologies and methods do not adequately address the complicated nature of drilling. Accordingly, what is needed are systems and methods to improve drilling operations and to improve drilling site safety.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a computer vision system includes at least one camera having a field of view of at least a portion of a drilling rig and/or a drilling site and a computer vision processor communicatively coupled to the camera. The computer vision processor may receive visual data from the camera, identify a control zone of the portion of the drilling rig and/or the drilling site within the field of view, and identify a person in the field of view, which may be based on a detection of a head and a body of the person, an item of clothing, an item of personal protective equipment, and/or combinations thereof. In certain embodiments, responsive to identifying the person, the processor may determine whether the person is in a control zone, and, responsive to determining the person is in the control zone, implement a safety control response, which may be automatically implemented.

In various embodiments, the safety control response includes an activation of an alarm. The alarm may be various types of alarms as desired, such as but not limited to an auditory alarm, a visual alarm, or both. In certain embodiments, the alarm may be generated on a device on or associated with the drilling site and/or on a device remote from the drilling rig.

In certain embodiments, the safety control response includes a control of equipment of the drilling site, Control of the equipment may include but is not limited to halting operation of the equipment, altering operation of the equipment, and/or shutting down the equipment.

In some embodiments, the processor may maintain the safety control response until the person exits the control zone.

According to certain embodiments, a method includes receiving visual data from at least one camera having a field of view of at least a portion of a drilling rig and/or a drilling site, identifying a control zone of the portion of the drilling rig and/or the drilling site within the field of view, identifying a person in the field of view based on a detection of a head and/or a body of the person, an item of clothing, an item of personal protective equipment, and/or combinations thereof, responsive to identifying the person, determining whether the person is in the control zone, and responsive to determining the person is in the control zone, implementing a safety control response.

According to certain embodiments, a computer vision system includes at least one camera having a field of view of at least a portion of a drilling site and a computer vision processor communicatively coupled to the camera. The computer vision processor may receive visual data from the camera and identify a plurality of control zones of the portion of the drilling site within the field of view and relative to one or more pieces of equipment. In certain embodiments, the plurality of control zones include at least a first control zone and a second control zone. The processor may identify a person in the field of view, and, responsive to identifying the person, determine whether the person is in one of the plurality of control zones and/or is moving into or is likely to move from one zone to another. In certain embodiments, responsive to determining the person is in the first control zone, the processor may implement a first safety control response, and responsive to determining the person is in the second control zone, the processor may implement a second safety control response different from the first safety control response.

In various embodiments, the first control zone is adjacent to the equipment and between the second control zone and the equipment. In some cases, the first control zone is more proximate to the equipment than the second control zone is to the equipment.

In some embodiments, the first safety control response includes a control of operation of the equipment or other associated equipment, and the second safety control response comprises an activation of an alarm, or vice versa. Optionally, at least one safety control response includes both control of equipment and activation of an alarm.

In certain cases, the processor may maintain the first safety control response while the person is in the first control zone and may maintain the second safety control response while the person is in the second control zone.

According to certain embodiments, a method includes receiving visual data from the camera having a field of view of at least a portion of a drilling rig and/or a drilling site and identifying a plurality of control zones of the portion of the drilling rig and/or the drilling site within the field of view and relative to at least one piece of equipment where the plurality of control zones include at least a first control zone and a second control zone. The method includes identifying a person in the field of view, and, responsive to identifying the person, determining whether the person is in one of the plurality of control zones. The method includes responsive to determining the person is in the first control zone, implementing a first safety control response, and responsive to determining the person is in the second control zone, implementing a second safety control response different from the first safety control response.

According to certain embodiments, a computer vision system includes at least one camera having a field of view of at least a portion of a drilling site and a computer vision processor communicatively coupled to the camera. The computer vision processor may receive visual data from the camera, identify a control zone of the portion of the drilling site within the field of view, and identify a person in the field of view. In certain embodiments, responsive to identifying the person, the processor may determine whether the person is the control zone, and responsive to determining the person is in the control zone, implement a safety control response and maintaining the safety control response until the person exits the control zone.

In various embodiments, the safety control response includes an activation of an alarm, such as but not limited to an auditory alarm, a visual alarm, or both. Additionally, or alternatively, the safety control response may include control of equipment of the drilling site. As non-limiting examples, control of equipment may include halting operations, altering operations, initiating operations, and/or shutting down the equipment. Optionally, the safety control response includes generating an alert notification on one or more remote devices such as a text message, an email message, a voice message, and/or visual or auditory alerts.

In some embodiments, the processor may control the safety control response based on a detected proximity of the person to equipment while the person is within the control zone.

According to certain embodiments, a method includes receiving visual data from the camera having a field of view of at least a portion of a drilling site and identifying a control zone of the portion of the drilling site within the field of view. The method includes identifying a person in the field of view, and responsive to identifying the person, determining whether the person is the control zone, or is moving into or likely to move into the control zone. In certain embodiments, the method includes, responsive to determining the person is in the control zone, implementing a safety control response and maintaining the safety control response until the person exits the control zone.

According to certain embodiments, non-transitory computer readable storage medium includes a plurality of instructions executable by one or more processors, which, when executed on the one or more processors, cause the one or more processors to perform actions described herein.

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates a drilling site with a personnel detection system according to embodiments.

FIG. 2 is a representation of a portion of the drilling site of FIG. 1 according to embodiments and is not drawn to scale.

FIG. 3 illustrates an example of personnel detection at the drilling site of FIG. 1 using the personnel detection system according to embodiments.

FIG. 4 illustrates personnel detection at the drilling site of FIG. 1 using the personnel detection system according to embodiments.

FIG. 5 is another view of the drilling site of FIG. 1 with the personnel detection system having a one or more control zones according to embodiments.

FIG. 6 illustrates a method according to embodiments.

### DETAILED DESCRIPTION

Described herein are systems and methods for identifying, monitoring, and tracking personnel at a drilling site and control of activities at the drilling site based on the detected personnel. In certain embodiments, the systems and methods described herein may provide improved safety at a drilling site and identify when one or more persons are in an unsafe area. In some embodiments, the systems and methods described herein may provide improved identification and detection of a person at a drilling site by identifying and detecting a unique characteristic or combination of characteristics for a person on the drilling site. As a non-limiting example, the improved detection may be based on identification of both a head and a body of a person, an identification of a hardhat or other gear of the person, a mark or other feature on clothing (e.g., an “X” made with reflective material on a vest, hardhat, or other piece of clothing), combinations thereof, and/or as otherwise desired.

In various embodiments, the systems and methods described herein may generate various safety control responses based on the identification of one or more persons in an unsafe area, such as but not limited to generating an alarm and/or controlling equipment (e.g., by altering, halting, initiating, and/or shutting down operations of the equipment). In certain embodiments, the systems and methods described herein may maintain the one or more safety control responses until the risk is mitigated (e.g., the person leaves the unsafe area), thereby providing improved safety to the person and/or control of equipment.

In some embodiments, the systems and methods described herein may utilize one or more safety control zones relative to equipment on the drilling site, and the safety control response implemented may be based on which safety control zone the person is identified as being in. In some embodiments, the location of the safety control zones may be based on proximity to a piece of equipment and/or the type of safety control response may be based on a proximity to the piece of equipment. In other embodiments, the safety control zones may provide zonal monitoring and safety control responses as desired.

Various other benefits and advantages may be realized with the systems and methods described herein, and the aforementioned benefits and advantages should not be considered limiting.

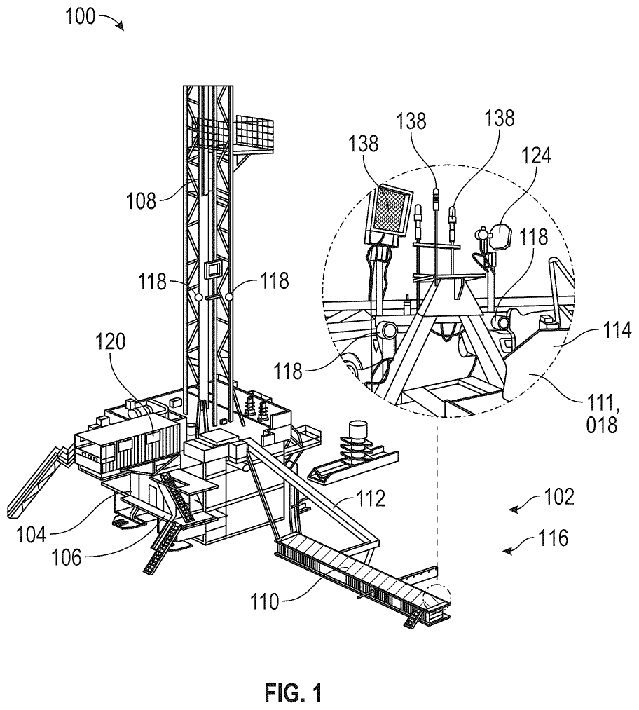

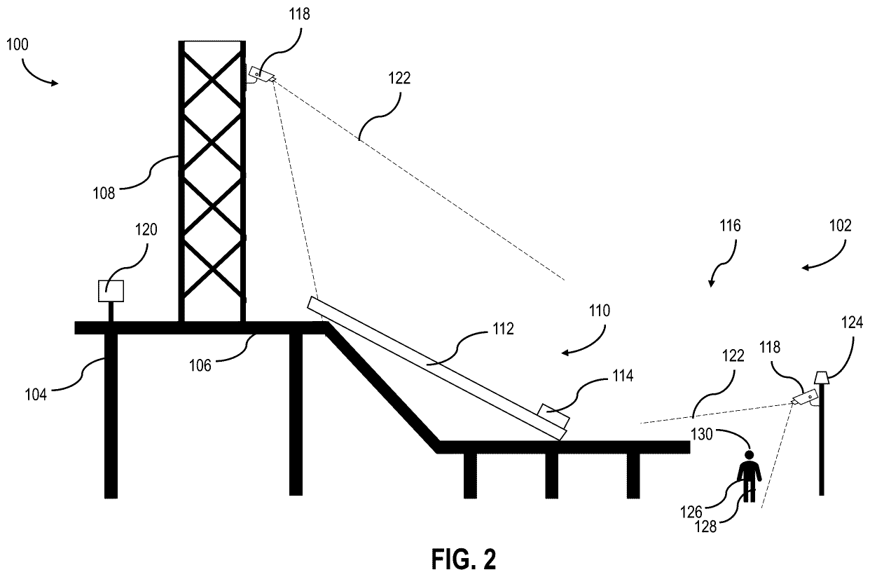

FIGS. 1-5 illustrate a drilling site 100 with a personnel detection system 102 according to embodiments.

The drilling site 100 may include a drilling rig 104 with various components, machinery, and equipment for performing drilling operations and situated relative to a well bore. As non-limiting examples, the drilling rig 104 may include components, machinery, and/or equipment such as a support structure 106, mast 108, crown block, top drive, traveling block, mud pump, shale shaker, mud gas separate, pipe delivery system 110 including a trough 112 and bucket 114, combinations thereof, and/or other components, machinery, and/or equipment as desired. Another non-limiting example of components of a drilling rig 104 is described in U.S. Pat. No. 10,957,177 to Michalopulos et al., issued on Mar. 23, 2021, and entitled SYSTEMS AND METHODS FOR OILFIELD DRILLING OPERATIONS USING COMPUTER VISION, (“177 Patent”) the content of which is hereby incorporated by reference in its entirety.

The personnel detection system 102 includes a computer vision system 116 with one or more cameras 118 and a controller 120 (processor and/or memory) communicatively coupled to the one or more cameras 118, Optionally, the personnel detection system 102 includes one or more alarm systems 124 as discussed in detail below.

The one or more cameras 118 may be various types of cameras or devices suitable for capturing one or more images. As non-limiting examples, the one or more cameras 118 may be visible light cameras such as grayscale, color, RGB, and/or other visible light cameras. In some embodiments, one or more cameras 118 may be cameras capable of observing light outside the visible spectrum, such as infrared, near infrared, or ultraviolet cameras. In some embodiments, the one or more cameras 118 may include cameras that are capable of recording distance or ranging information, such as time-of-flight cameras or LIDAR sensors, Such one or more time-of-flight or LIDAR sensors or cameras can be used to provide accurate distance, size, shape, dimensions, and other important physical information about components in a field of view as discussed in detail below. In some embodiments, the one or more cameras may include arrays of cameras, wide-angle, 360 degree cameras, or other such image capturing devices. The one or more cameras 118 may be video cameras, or may be cameras taking still images, or a combination thereof. In some embodiments, by including many cameras, aspects of the present disclosure can be resilient against individual camera failures by switching to use as input another camera that has not failed. In some embodiments, interpretative processing can be used to fill gaps in image data caused by transmission dropout, blind spots, or other occlusions to monitor aspects of the drilling site that are temporarily or permanently not visible to the one or more cameras 118. Any number of cameras 118 may be utilized, and when a plurality of cameras 118 are utilized, they need not be the same type of camera 118. As a non-limiting example, one camera 118 may be a visible light camera, another camera may be an infrared camera, and yet another camera may be a video camera.

The one or more cameras 118 may be provided at various locations and/or at various orientations relative to the drilling site 100 such that each of the one or more cameras 118 has a field of view 122 of at least a portion of the drilling site 100. In this regard, the one or more cameras may observe and/or monitor the portions of the drilling site 100 within the field of view 122 as discussed in detail below. In some embodiments, the one or more cameras 118 are arranged to have a field of view 122 of a particular component, equipment, or machinery of the drilling site 100. In the embodiments illustrated and described herein, the one or more cameras 118 are arranged to have fields of view 122 of at least a portion of the pipe delivery system 110. However, in other embodiments, the one or more cameras may be arranged to have fields of view that include other portions of the drilling site 100 and/or a plurality of components, equipment, or machinery of the drilling site 100 as desired.

Where a plurality of cameras 118 are utilized, the location and/or orientation of one camera 118 need not be the same as another camera 118. In the embodiment illustrated, one or more cameras 118 are provided on the mast 108 and oriented to have a top-down field of view 122 of at least a portion of the pipe delivery system 110. In other words, the one or more cameras 118 are provided at a vertical height above the pipe delivery system 110.

In the embodiment illustrated, one or more cameras 118 are additionally provided proximate to an end of the pipe delivery system 110 to have a more horizontal field of view 122 of at least a portion of the pipe delivery system 110 compared to those cameras 118 on the mast 108. In other embodiments, the one or more cameras 118 may be provided at other locations and/or orientations to view at least portions of the pipe delivery system 110. Similarly, in other embodiments, the one or more cameras 118 may be provided at various locations and/or orientations for detecting other portions of the drilling site 100 as desired. Optionally, the location and/or orientation of the one or more cameras 118 may be based on a particular area of the drilling site 100 and/or machinery, equipment, or components within such an area.

Various other combinations of types of cameras 118, locations of cameras 118, and/or orientations of cameras 118 may be utilized as desired.

The controller 120 may include and/or be a computer system and/or one or more processing units and/or one or more memory devices. The processing unit may be various suitable processing devices or combinations of devices including but not limited to one or more application specific integrated circuits, digital signal processors, digital signal processing devices, programmable logic devices, field programmable gate arrays, processors, controllers, micro-controllers, microprocessors, other electronic units, and/or a combination thereof. The one or more memory devices may be any machine-readable medium that can be accessed by the processor, including but not limited to any type of long term, short term, volatile, nonvolatile, or other storage medium, and is not to be limited to any particular type of memory or number of memories, or type of media upon which memory is stored. Moreover, as disclosed herein, the term “storage medium,” “storage” or “memory” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to, portable or fixed storage devices, optical storage devices, wireless channels, and/or various other storage mediums capable of storing that contain or carry instruction(s) and/or data.

In various embodiments, the controller 120 may be communicatively coupled to one or more rig control systems and/or equipment for controlling one or more operations or activities at the drilling site 100. Non-limiting examples of rig control systems and/or equipment include steering control systems, weight on bit control systems, pressure control systems, positional control systems, rotary control systems, fluid circulation control systems, a top drive, mud pumps, a wireline, a traveling block, a shale shaker, a pipe delivery system, conveyors, cranes, hoists, pumps, drilling equipment, carts, sleds, elevators, winches, industrial equipment, combinations thereof, and/or other systems and/or equipment as desired. In the embodiment illustrated, the controller 120 may be communicatively coupled to one or more rig control systems for the pipe delivery system 110, such as but not limited to various controls for the handling and delivery of one or more drill pipes. Examples of such control systems and related equipment are described in U.S. Pat. No. 8,210,283, issued on Jul. 3, 2012, and entitled “System and Method for Surface Steerable Drilling” (“'283 Patent”), and in U.S. application Ser. No. 17/812,850, filed on Jul. 15, 2022, and entitled “Apparatus and Methods for Uninterrupted Drilling” (“'850 Application”), each of which is hereby incorporated by reference in its entirety.

The controller 120 may be provided at various locations relative to the one or more cameras 118 and/or relative to the drilling site 100. In FIG. 1, the controller 120 is located at or within in a cabin 121, although in other embodiments the controller may be at other locations or combinations of locations as desired. In some embodiments, the controller 120 may be a dedicated and/or stand-alone system, although it need not be in other examples. In some embodiments, the controller 120 (and/or portions or sub-components thereof) may be coupled to and/or combined with any other equipment, other control systems of the drilling site 100 (e.g., such as those described in the '030 Patent, the '230 Publication, the '242 Application, the '631 Application, the '177 Patent, the '283 Patent, and/or the '850 Application, among others), other control systems, combinations thereof, and/or as otherwise desired. As a non-limiting example, the controller 120 may be coupled to or combined with a rig control system. In some embodiments, the controller 120 may send and/or receive information with other control systems. Thus, while illustrated as separate from the one or more cameras 118 and other equipment of the drilling site 100, in some embodiments, the controller 120 (or sub-components thereof such as one or more processing units and/or one or more memory devices) may be components of one or more cameras 118 and/or other equipment and/or other control systems as desired.

In certain embodiments, the controller 120 optionally includes an associated user interface, including but not limited to a graphical user interface or a human machine interface, such that the controller 120 may obtain information from a user and/or provide information to the user. In such embodiments, the user interface and/or human machine interface may be on the controller 120 itself or may be at a location remote from the controller 120, such as on a user device, a dedicated user interface device, an operations control center remote from the drilling site 100, combinations thereof, and/or as otherwise desired.

In certain embodiments, the controller 120 may receive visual data from the one or more cameras 118 and analyze the visual data.

Based on the visual data from the one or more cameras 118, the controller 120 may monitor and detect one or more personnel 126 within the field of view 122 of one or more cameras 118 and/or on the drilling site 100, The controller 120 may utilize various techniques or processes to identify the one or more personnel 126. A non-limiting example of techniques or processes used by the controller 120 is described in U.S. Pat. No. 10,958,877 to Torrione et al., issued on Mar. 23, 2021, and entitled SYSTEM AND METHOD FOR INHIBITING OR CAUSING AUTOMATED ACTIONS BASED ON PERSON LOCATIONS ESTIMATED FROM MULTIPLE VIDEO SOURCES, the content of which is hereby incorporated by reference in its entirety.

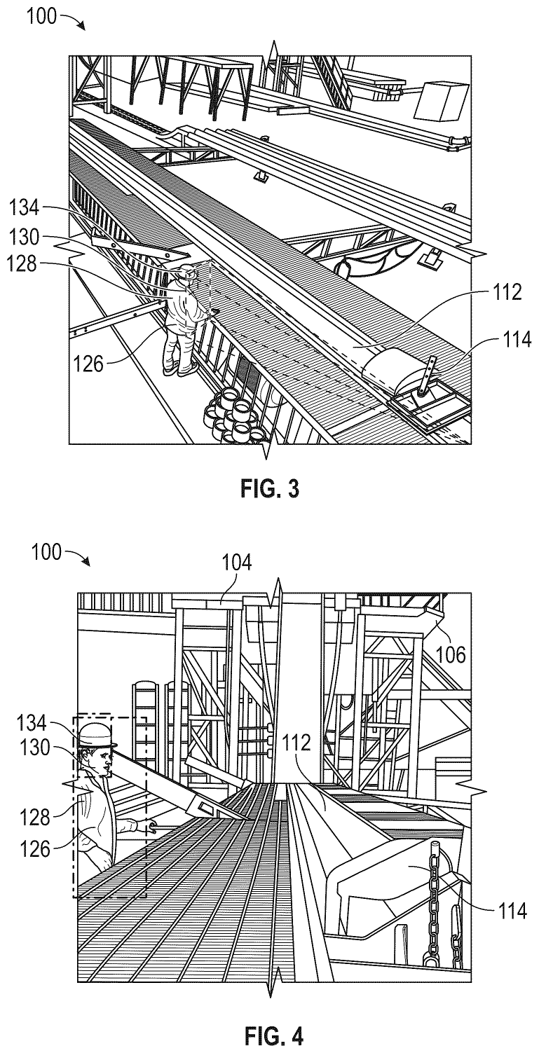

In certain embodiments, the controller 120 may provide improved detection and identification of one or more personnel 126 compared to traditional approaches. In some embodiments, and as illustrated in FIGS. 3 and 4, the controller 120 may detect and identify an object as one or more personnel 126 based on a detection of two or more human characteristics of the object in the visual data. As a non-limiting example, the controller 120 may detect and identify an object in the visual data as one or more personnel 126 based on the detection of a body 128 and a head or face 130. In another non-limiting example, the controller 120 may detect and identify an object in the visual data as a person based on the detection of the head and/or face 130 and/or based on a rate of movement, pose, and/or other type of movement of the object in the field of view 122. In certain embodiments, identifying an object in the visual data as a person based on the detection of two or more human characteristics, pose, type, and/or rate of movement may provide improved confidence that the object is a person and reduce false alarms due to misidentification of non-human objects as a person. In some embodiments, the identification of an object of a person may be given a confidence value. Moreover, the computer vision system may be programmed such that certain responses (such as but not limited to those detailed below) only occur when the confidence value exceeds one or more thresholds. It should be understood that some responses may require a higher confidence value threshold than others.

Additionally, or alternatively, the controller 120 may provide improved detection and identification of an object as a person based on a detection of clothing and/or personal protective equipment, such as but not limited to a hardhat, eye protection, protective clothing, etc. In certain embodiments, utilizing the detection of personal protective equipment to identify an object as a person rather than a human characteristic of the object itself may allow for improved detection (and possibly also a high confidence value) regardless of the location and/or orientation of the one or more cameras 118. As a non-limiting example, while the one or more cameras 118 on the mast 108 may not have a field of view 122 where the face 132 is visible (and thus the person would not ordinarily be detected), identification of personal protective equipment such as a hardhat 134, reflective marks, clothing, etc. may be utilized to identify an object as a person. Moreover, characteristics of such equipment or clothing may be utilized to identify an object as a person. As non-limiting examples, a color of clothing or a hardhat, a marking on clothing (e.g., an “X” marking of reflective material on clothing and/or a hardhat), etc. may be utilized to identify an object as a person. In addition to allowing personnel detection regardless of the location and/or orientation of the one or more cameras 118, using personal protective equipment to identify one or more objects as a person may provide improved confidence and reduce false alarms potentially due to variations in shape and size of personnel. As non-limiting examples, while personnel on the drilling site 100 may be in various shapes, heights, sizes, colors, etc., personal protective equipment such as hardhats 134 remain generally consistent and/or with reduced variation. As a non-limiting example, hardhats 134 may be generally round with a bulge at the top regardless of the particular person wearing them, thereby providing generally consistent characteristics and/or characteristics with reduced variation for detection by the controller 120.

In certain embodiments, the controller 120 may provide improved detection and identification of equipment, machinery, and/or other components of the drilling site 100 compared to traditional approaches. In various embodiments, the controller 120 may identify an object as a piece of equipment and optionally may identify an operating state of the equipment from the visual data. As a non-limiting example, the controller 120 may identify the pipe delivery system 110 with the trough 112 and the bucket 114 in the visual data. In some embodiments, the controller 120 may detect movement of one or more pieces of equipment and/or positions of one or more pieces of equipment. The positions and/or movement may be relative to the drilling site 100 and/or relative to other pieces of equipment. As non-limiting examples, the controller 120 may detect one or more pipes in the trough of the pipe delivery system 110. The controller 120 may further identify various states of the pipe delivery system 110 based on the detected position and/or movement of the equipment. As non-limiting examples, the controller 120 may identify states such as but not limited to whether the pipe delivery system 110 is on or off, whether a trough of the pipe delivery system 110 is in an up or down position, and/or whether the trough of the pipe delivery system 110 is full or empty.

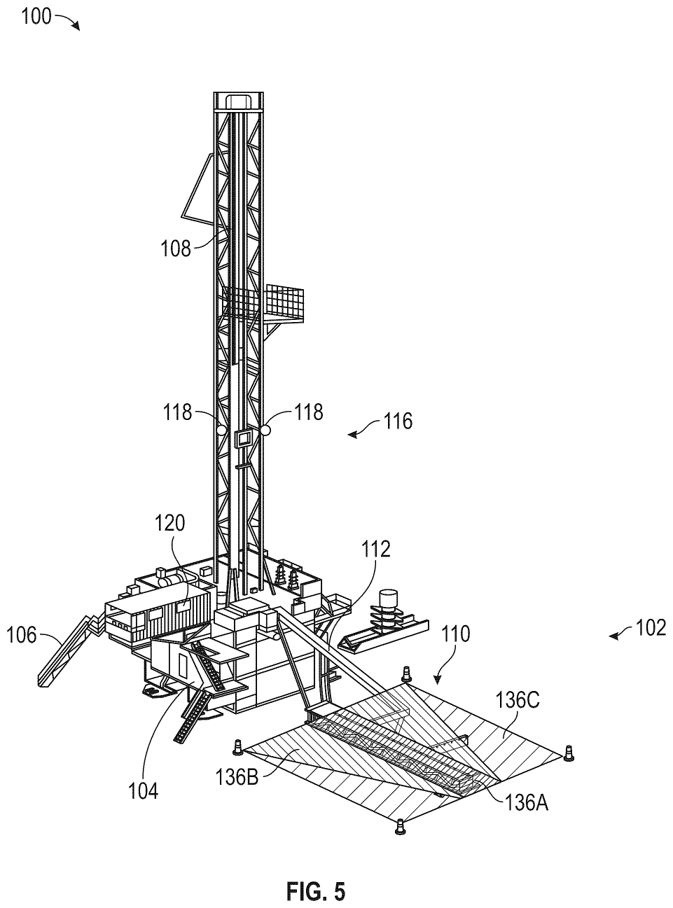

In some embodiments, in addition to detecting one or more pieces of equipment (e.g., detecting the pipe delivery system 110 or a sub-component such as the trough 112 and/or bucket 114) and/or the movement of one or more pieces of equipment, the controller 120 may identify one or more control regions 136 relative to the equipment. As a non-limiting example, FIG. 5 illustrates the identification of the pipe delivery system 110, a first control region 136A that includes the pipe delivery system 110, a second control region 136B adjacent to the first control region 136A but not including the pipe delivery system 110, and a third control region 136C where the second control region 136B is between the third control region 136C and the first control region 136A. The number, shape, size, and location of the one or more control regions 136 should not be considered limiting.

In some embodiments, the one or more control regions 136 may be defined by the controller 120 based on a proximity or distance to a particular piece of equipment. The proximity or distance defining each of the one or more control regions 136 may be provided by a user and/or may be determined by the controller 120. In embodiments where the controller 120 defines the one or more control regions 136, the one or more control regions 136 may be determined based on a detected type of equipment in the visual data, other fiducials or artifacts in the visual data, and/or as otherwise required. As a non-limiting example, based on an identification of the pipe delivery system 110 in the visual data, the controller 120 may determine the first control region 136A including the pipe delivery system. 110 to have a first shape, profile, and/or area, determine the second control region 136B to have a second shape, profile, and/or area, and determine the third control region 136C to have a third shape, profile, and/or area. In certain embodiments, the control regions 136 may be defined based on the locations and orientations of the one or more cameras 118. As a non-limiting example, the one or more cameras 118 on the mast 108 may be at a known height and known orientation relative to the pipe delivery system 110, and based on this information, the controller 120 may determine a number of pixels corresponding to a known distance (e.g., a certain number of pixels correspond to 40 ft.). The pixels corresponding to the known distance may be utilized to identify and define the control regions 136 in the visual data.

Additionally, or alternatively, the controller 120 may identify and define the one or more control regions 136 based on the detection of physical boundaries in the visual data and optionally such that the control regions 136 correspond to true physical boundaries. As an example, the controller 120 may identify cones, chains, fences, and/or other objects defining a physical boundary in the visual data and relative to the equipment and may identify and define control regions 136 based on the identified physical boundaries. As a non-limiting example and referring to FIG. 5, the first control region 136A may be defined by the controller 120 corresponding to a fence surrounding the pipe delivery system 110 of the pipe delivery system 110 as detected in the visual data, and the boundary between the second control region 136B and the third control region 136C may be defined by the controller 120 corresponding to cones detected in the visual data.

In various embodiments, the controller 120 may identify and track the person relative to the equipment and control regions 136 based on the visual data and detect and/or determine when the detected person is within the one or more control regions 136. In various embodiments, the controller 120 may generate a safety control response based on the determination that the identified person is within the one or more control regions 136. The safety control response may be various responses as desired.

In some embodiments, the rig site may have a tubular loading system like that described in U.S. provisional patent application Ser. No. 63/583,997, filed on Sep. 20, 2023, and titled “Tubular Handling Apparatus and Methods,” which is incorporated by reference herein. The controller 120 and personnel detection system 102 may be coupled to such a tubular loading system, and the controller 120 may be programmed so that it receives information from the tubular handling system regarding its operations, and such that the controller 120 may predict subsequent operations of the tubular handling system and the timing of such operations, By using information regarding the current state of the tubular handling system, the expected subsequent state or states, and the expected timing thereof, the controller 120 may better predict and detect an existing or likely to occur unsafe condition when a person is detected in a control zone associated with the tubular handling system, and then provide one or more alerts, alarms, or send control signals to take other actions as appropriate for the safety of the person detected.

In some embodiments, the safety control response may include activating the one or more alarm systems 124. The one or more alarm systems 124 may be various types of alarm systems as desired, such as but not limited to alarm systems for generating auditory or audible alerts, visual alerts, combinations thereof, and/or other alerts as desired. As non-limiting examples, the alarm systems 124 may include alerting devices 138 such as but not limited to lights, speakers, displays, combinations thereof, and/or other types of alerting devices as desired. In the embodiment illustrated, the one or more alarm systems 124 include both lights and speakers as alerting devices 138 such that the alarm systems 124 may provide auditory and/or visual alerts. In certain embodiments, a plurality of types of alert devices and/or alert devices 138 with one or more controllable characteristics may be utilized such that various safety control responses may be implemented. As non-limiting examples, different types of lights (e.g., strobe, flood, etc.), lights with controllable light output (e.g., color, frequency, pattern, brightness, etc.), different types of speakers and/or other audio output, speakers and/or other output with controllable sound output (e.g., volume, pitch, frequency, type, etc.) may be utilized. In other embodiments, the one or more alarm systems 124 may provide other alerts or notifications as desired. In some embodiments, visual and/or auditory alarms may be provided on one or more cell phones, tablets, and/or computer screens, each of which may be associated with users of one or more of the drilling site and/or one or more remote locations. The alarms may also include sending one or more text messages, robocalls, and/or emails to one or more such devices at one or more such locations.

In various embodiments, the safety control response may include generating or sending an alert or notification to one or more remote devices. As non-limiting examples, the safety control response may include sending an alert or notification to a user device, to a remote operation control center, generating an alert or notification on an application running on a device, combinations thereof, and/or other responses as desired.

In certain embodiments, the safety control response may include controlling operation of one or more pieces of equipment, machinery, and/or components of the drilling site 100. As non-limiting examples, the safety control response may include altering, halting, initiating, and/or shutting down operation of equipment, machinery, and/or other components. As non-limiting examples, altering operations may include changing a direction of movement or motion of equipment and/or changing a type of operation being performed by equipment; halting operations may include temporarily stopping an operation being performed by equipment; initiating operations may include activating a previously inactive piece of equipment; and shutting down operations may include turning off, powering down, and/or otherwise ceasing operations of the equipment. As a non-limiting example, altering operations may include changing a direction of movement or motion of pipe and/or changing a type of operation being performed by equipment handling the pipe; halting operations may include temporarily stopping an operation being performed by equipment handling the pipe; initiating operations may include activating a previously inactive piece of equipment for handling the pipe; and shutting down operations may include turning off, powering down, and/or otherwise ceasing operations of the equipment handling the pipe.

As a non-limiting example, the control response may include controlling various equipment of the pipe delivery system 110. In some embodiments, control responses with the pipe delivery system 110 may include, but are not limited to, stopping the raising or lowering of pipe and/or the trough of the pipe delivery system 110, raising guard rails or other blocking devices or systems to stop the movement of pipe to the trough of the pipe delivery system 110, stopping elevators of the pipe delivery system 110, stopping makeup operations (e.g., fastening tools together), stopping breakout operations (e.g., unfastening tools), combinations thereof, and/or various other controls as desired.

In embodiments with a plurality of controls regions (e.g., as illustrated in FIG. 5), each control region may have a corresponding safety control response that may or may not be different from a safety control response for another control region 136. As non-limiting examples, a safety control response based on detection of the person in the first control region 136A may include shutting down operations of the pipe delivery system 110, a safety control response based on detection of the person in the second control region 136B may include halting operations of the pipe delivery system 110, and a safety control response based on the detection of the person in the third control region 136C may include generating an auditory and/or visual alarm using the alarm system 124. As another non-limiting example, a first safety control response for the first control region 136A may be a visual and/or auditory alarm with a first characteristic (e.g., frequency, intensity, brightness, loudness, etc.), and a second safety control response for the second control region 136B may be a visual and/or auditory alarm with a second characteristic different from the first characteristic. Other combinations of control responses may be implemented as desired.

In certain embodiments, the controller 120 may maintain the safety control response while the person is detected within one or more control regions 136. As non-limiting examples, the controller 120 may halt operation of the pipe delivery system 110 and/or generate a visual and/or auditory alert while the person is detected within at least one control region 136. The controller may stop the alerts and/or resume operations when the person is detected exiting and/or has left the control region.

In some embodiments, upon a determination that a person is not within at least one control region 136, the controller 120 may wait a buffer time period before stopping the safety control response. As a non-limiting example, once the controller 120 no longer detects the person within a control region 136, the controller 120 may wait five seconds (or any other duration) before stopping an auditory alert from a horn and allowing normal operations of the equipment to resume. The buffer time period may be predetermined in some embodiments, although it need not be in other embodiments. In some cases, the buffer time period between the last detection of the person within a control region 136 and the cessation of the safety control response may facilitate ensuring that unsafe conditions are no longer present and/or the control zone if clear of personnel.

In some embodiments, in addition to generating the safety control response based on the detection of the person within a control region 136, the controller 136 may generate the safety control response based on the detected operating state of the equipment. Table 1 illustrates a non-limiting example of various safety control responses that may be implemented based on a detection of a person within one of the control regions 136A-C relative to the pipe delivery system 110 and the operating status of equipment of the pipe delivery system 110. In Table 1, Response 1 is an auditory alarm and a visual alert, Response 2 is a halting or freezing of the pipe delivery system 110 in place, and Response 3 is a shutting down of the pipe delivery system 110 (e.g., by shutting down hydraulics). Pipe delivery system is abbreviated as “PDS” in Table 1.

TABLE 1

| Operational Status | | | | |
|---|---|---|---|---|
| | Trough Up/ | Trough Full/ | | |
| PDS on? | Down? | Empty? | Control Zone | Response Type |
| Yes | Down | Either | 136A-C | Response 3 |
| Yes | Up | Empty | 136A-C | Response 2 |
| Yes | Up | Full | 136A-C | Response 3 |
| No | Up | Either | 136A-C | Response 2 |
| No | Down | Either | 136A-C | Response 1 |

In other embodiments, other safety control responses may be implemented based on personnel detection and equipment operational status as desired.

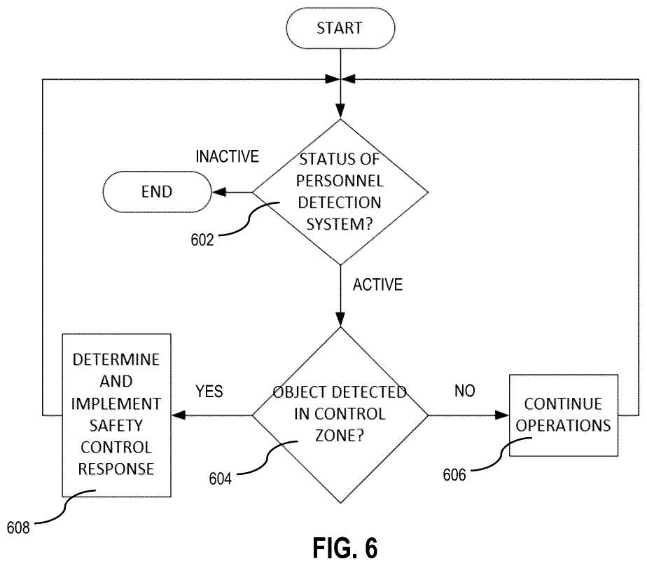

FIG. 6 illustrates an example of a method of controlling drilling operations using the personnel detection system 102 according to embodiments. The method is for illustrative purposes, and other methods and controls may be implemented using the systems described herein. The method may be implemented in whole or in part by one or more computer systems. The one or more computer systems may comprise or be coupled with a system that monitors and/or controls drilling operations. An example of such a system is described in U.S. Pat. No. 8,210,293 to Benson et al., issued on Jul. 3, 2012, and entitled SYSTEM AND METHOD FOR SURFACE STEERABLE DRILLING, the content of which is hereby incorporated by reference in its entirety.

In a block 602, a status of the personnel detection system 102 may be determined. In various embodiments, a determination that the personnel detection system 102 is off or inactive in block 602 will allow for personnel to be in various areas on the drilling site 100 without generating any safety control responses such as alarms, equipment control, etc. In various embodiments, a determination that the personnel detection system 102 is on or active in block 602 will indicate that the computer vision system 116 is actively monitoring portions of a drilling site 100 for person detection.

In a block 604, the method includes determining whether a person or object is in one or more control regions 136. As noted above, the method may also include tracking movement and determining whether a person is about to and/or is likely to move into one or more control regions.

In a block 606, based on a determination that a person or object is not within one or more control regions 136, operation of the equipment may continue, and the method returns to block 602.

In a block 608, based on a determination that a person or object is within one or more control regions 136, the system may determine a safety control response. In some embodiments, block 608 includes determining a type of safety control response based on the particular control regions 136 and optionally based on an operational status of the equipment. As non-limiting examples, block 608 may include generating an alarm, controlling operations of one or more pieces of equipment, and/or sending a notification to one or more users. Block 608 may include maintaining the safety control response until the risk is mitigated, and the method may return to block 602. As noted above, a confidence value may be assigned to the determination that a person is in a control region, and the confidence value may be used to determine whether one or more control responses should be triggered.

In certain embodiments, the loops of blocks may be repeated continuously and/or as otherwise desired. In various embodiments, the method may be repeated while the personnel detection system is active or on.

Other controls may be implemented using the systems described herein, and the aforementioned examples should not be considered limiting.

Various other benefits and advantages may be realized with the systems and methods described herein, and the aforementioned benefits and advantages should not be considered limiting.

A collection of exemplary embodiments are provided below, including at least some explicitly enumerated as “Illustrations” providing additional description of a variety of example embodiments in accordance with the concepts described herein. These illustrations are not meant to be mutually exclusive, exhaustive, or restrictive; and the disclosure not limited to these example illustrations but rather encompasses all possible modifications and variations within the scope of the issued claims and their equivalents.

Illustration 1. A system for improving safety for drilling operations, the system comprising: at least one camera having a field of view of at least a portion of a drilling site; a computer vision processor communicatively coupled to the camera, wherein the computer vision processor is configured to: receive visual data from the camera; identify a control zone of the portion of the drilling site within the field of view; identify a person in the field of view based on a detection of a head and a body of the person; responsive to identifying the person, determine whether the person is in the control zone; and responsive to determining the person is in the control zone, implement a safety control response.

Illustration 2. The system of any preceding or subsequent illustrations or combination of illustrations, wherein the safety control response comprises an activation of an alarm, and wherein the alarm is an auditory alarm, a visual alarm, a text message, a voice message, a video message, an email, or a combination of some or all of the foregoing.

Illustration 3. The system of any preceding or subsequent illustrations or combination of illustrations, wherein the safety control response comprises a control of equipment of the drilling site.

Illustration 4. The system of any preceding or subsequent illustrations or combination of illustrations, wherein the control of equipment comprises halting or shutting down operation of the equipment.

Illustration 5. The system of any preceding or subsequent illustrations or combination of illustrations, wherein the safety control response comprises an alert notification on a device located remote from the drilling site.

Illustration 6. The system of any preceding or subsequent illustrations or combination of illustrations, wherein the processor is configured to maintain the safety control response until the person exits the control zone.

Illustration 7. A method for drilling, the method comprising: receiving, by a computer vision system, visual data from at least one camera having a field of view of at least a portion of a drilling site, wherein the portion of the drilling site comprises a portion of a pipe delivery system; identifying, by the computer vision system, a control zone of the portion of the drilling site within the field of view; identifying, by the computer vision system, a person in the field of view based on a detection of a head and a body of the person; responsive to identifying the person, determining, by the computer vision system, whether the person is in the control zone; and responsive to determining the person is in the control zone, implementing, by the computer vision system, a safety control response.

Illustration 8. The method of any preceding or subsequent illustrations or combination of illustrations, wherein implementing the safety control response comprises activating an alarm, and wherein the alarm is an auditory alarm, a visual alarm, a text message, a voice message, a video message, an email, or a combination of some or all of the foregoing.

Illustration 9. The method of any preceding or subsequent illustrations or combination of illustrations, wherein implementing the safety control response comprises controlling equipment of the drilling site.

Illustration 10. The method of any preceding or subsequent illustrations or combination of illustrations, controlling the equipment comprises halting or shutting down operation of the equipment.

Illustration 11. The method of any preceding or subsequent illustrations or combination of illustrations, wherein implementing the safety control response comprises generating an alert notification on a device located remote from the drilling site.

Illustration 12. The method of any preceding or subsequent illustrations or combination of illustrations, further comprising maintaining the safety control response until the person exits the control zone.

Illustration 13. A non-transitory computer readable storage medium comprising a plurality of instructions executable by one or more processors, which, when executed on the one or more processors, cause the one or more processors to perform actions including: receiving visual data from at least one camera having a field of view of at least a portion of a drilling site, wherein the portion of the drilling site comprises a portion of a pipe delivery system; identifying a control zone of the portion of the drilling site within the field of view; identifying a person in the field of view based on a detection of a head and a body of the person; responsive to identifying the person, determining whether the person is in the control zone; and responsive to determining the person is in the control zone, implementing a safety control response.

14. The non-transitory computer readable storage medium of any preceding or subsequent illustrations or combination of illustrations, wherein the instructions for implementing the safety control response comprise instructions for activating an alarm, and wherein the alarm is an auditory alarm, a visual alarm, a text message, a voice message, a video message, an email, or a combination of some or all of the foregoing.

Illustration 15. The non-transitory computer readable storage medium of any preceding or subsequent illustrations or combination of illustrations, wherein the instructions for implementing the safety control response comprise instructions for controlling equipment of the drilling site.

Illustration 16. The non-transitory computer readable storage medium of any preceding or subsequent illustrations or combination of illustrations, wherein the instructions for controlling the equipment comprise instructions for halting or shutting down operation of the equipment.

Illustration 17. The non-transitory computer readable storage medium of any preceding or subsequent illustrations or combination of illustrations, wherein the instructions for implementing the safety control response comprise instructions for generating an alert notification on a device located remote from the drilling site.

Illustration 18. The non-transitory computer readable storage medium of any preceding or subsequent illustrations or combination of illustrations, wherein the instructions further comprise instructions for maintaining the safety control response until the person exits the control zone.

Illustration 19. A system for drilling, the system comprising: at least one camera having a field of view of at least a portion of a pipe delivery system at a drilling site; a computer vision processor communicatively coupled to the camera, wherein the computer vision processor is configured to; receive visual data from the camera; identify a plurality of control zones of the portion of the pipe delivery system within the field of view and relative to at least one piece of equipment, the plurality of control zones comprising at least a first control zone and a second control zone; identify a person in the field of view; responsive to identifying the person, determine whether the person is in one of the plurality of control zones; responsive to determining the person is in the first control zone, implement a first safety control response; and responsive to determining the person is in the second control zone, implement a second safety control response different from the first safety control response.

Illustration 20. The system of any preceding or subsequent illustrations or combination of illustrations, wherein the first control zone is adjacent to the equipment and between the second control zone and the equipment.

Illustration 21. The system of any preceding or subsequent illustrations or combination of illustrations, wherein the first control zone is more proximate to the equipment than the second control zone is to the equipment.

Illustration 22. The system of any preceding or subsequent illustrations or combination of illustrations, wherein the first safety control response comprises a control of operation of the equipment or other associated equipment, and wherein the second safety control response comprises an activation of an alarm.

Illustration 23. The system of any preceding or subsequent illustrations or combination of illustrations, wherein the first safety control response comprises the activation of the alarm.

Illustration 24. The system of any preceding or subsequent illustrations or combination of illustrations, wherein the processor is configured to maintain the first safety control response while the person is in the first control zone and to maintain the second safety control response while the person is in the second control zone.

Illustration 25. A method for drilling, the method comprising: receiving, by a computer vision system, visual data from at least one camera having a field of view of at least a portion of a drilling site; identifying, by the computer vision system, a plurality of control zones of the portion of the drilling site within the field of view and relative to at least one piece of equipment, the plurality of control zones comprising at least a first control zone and a second control zone; identifying, by the computer vision system, a person in the field of view; responsive, by the computer vision system, to identifying the person, determining whether the person is in one of the plurality of control zones; responsive to determining the person is in the first control zone, implementing, by the computer vision system, a first safety control response; and responsive to determining the person is in the second control zone, implementing, by the computer vision system, a second safety control response different from the first safety control response.

Illustration 26, The method of any preceding or subsequent illustrations or combination of illustrations, wherein the first control zone is adjacent to the equipment and between the second control zone and the equipment.

Illustration 27. The method of any preceding or subsequent illustrations or combination of illustrations, wherein the first control zone is more proximate to the equipment than the second control zone is to the equipment.

Illustration 28. The method of any preceding or subsequent illustrations or combination of illustrations, wherein implementing the first safety control response comprises controlling operation of the equipment or other associated equipment, and wherein implementing the second safety control response comprises activating an alarm.

Illustration 29. The method of any preceding or subsequent illustrations or combination of illustrations, wherein implementing the first safety control response comprises activating the alarm.

Illustration 30. The method of any preceding or subsequent illustrations or combination of illustrations, further comprising maintaining the first safety control response while the person is in the first control zone and maintaining the second safety control response while the person is in the second control zone.

Illustration 31. A non-transitory computer readable storage medium comprising a plurality of instructions executable by one or more processors, which, when executed on the one or more processors, cause the one or more processors to perform actions including: receiving visual data from at least one camera having a field of view of at least a portion of a drilling site; identifying a plurality of control zones of the portion of the drilling site within the field of view and relative to at least one piece of equipment, the plurality of control zones comprising at least a first control zone and a second control zone; identifying a person in the field of view; responsive to identifying the person, determining whether the person is in one of the plurality of control zones; responsive to determining the person is in the first control zone, implementing a first safety control response; and responsive to determining the person is in the second control zone, implementing a second safety control response different from the first safety control response.

Illustration 32. The non-transitory computer readable storage medium of any preceding or subsequent illustrations or combination of illustrations, wherein the first control zone is adjacent to the equipment and between the second control zone and the equipment.

Illustration 33. The non-transitory computer readable storage medium of any preceding or subsequent illustrations or combination of illustrations, wherein the first control zone is more proximate to the equipment than the second control zone is to the equipment.

Illustration 34. The non-transitory computer readable storage medium of any preceding or subsequent illustrations or combination of illustrations, wherein the instructions for implementing the first safety control response comprise instructions for controlling operation of the equipment or other associated equipment, and wherein the instructions for implementing the second safety control response comprise instructions for activating an alarm.

Illustration 35. The non-transitory computer readable storage medium of any preceding or subsequent illustrations or combination of illustrations, wherein the instructions for implementing the first safety control response comprise instructions for activating the alarm.

Illustration 36. The non-transitory computer readable storage medium of any preceding or subsequent illustrations or combination of illustrations, wherein the instructions further comprise instructions for maintaining the first safety control response while the person is in the first control zone and maintaining the second safety control response while the person is in the second control zone.

Illustration 37. A computer vision system comprising: at least one camera having a field of view of at least a portion of a drilling site; a computer vision processor communicatively coupled to the camera, wherein the computer vision processor is configured to: receive visual data from the camera; identify a control zone of the portion of the drilling site within the field of view; identify a person in the field of view; responsive to identifying the person, determine whether the person is the control zone; and responsive to determining the person is in the control zone, implement a safety control response and maintaining the safety control response until the person exits the control zone.

Illustration 38. The computer vision system of any preceding or subsequent illustrations or combination of illustrations, wherein the safety control response comprises an activation of an alarm.

Illustration 39. The computer vision system of any preceding or subsequent illustrations or combination of illustrations, wherein the alarm is an auditory alarm, a visual alarm, or both.

Illustration 40. The computer vision system of any preceding or subsequent illustrations or combination of illustrations, wherein the safety control response comprises a control of equipment of the drilling site.

Illustration 41, The computer vision system of any preceding or subsequent illustrations or combination of illustrations, wherein the control of equipment comprises halting or shutting down the equipment.

Illustration 42. The computer vision system of any preceding or subsequent illustrations or combination of illustrations, wherein the safety response comprises an alert notification on a remote device.

Illustration 43, The computer vision system of any preceding or subsequent illustrations or combination of illustrations, wherein the processor is configured to control the safety control response based on a detected proximity of the person to equipment while the person is within the control zone.

Illustration 44. A method for drilling, the method comprising: receiving visual data from at least one camera having a field of view of at least a portion of a drilling site; identifying a control zone of the portion of the drilling site within the field of view; identifying a person in the field of view; responsive to identifying the person, determining whether the person is the control zone; and responsive to determining the person is in the control zone, implementing a safety control response and maintaining the safety control response until the person exits the control zone.

Illustration 45. The method of any preceding or subsequent illustrations or combination of illustrations, wherein implementing the safety control response comprises activating an alarm.

Illustration 46. The method of any preceding or subsequent illustrations or combination of illustrations, wherein the alarm is an auditory alarm, a visual alarm, or both.

Illustration 47. The method of any preceding or subsequent illustrations or combination of illustrations, wherein implementing the safety control response comprises controlling equipment of the drilling site.

Illustration 48. The method of any preceding or subsequent illustrations or combination of illustrations, wherein controlling equipment comprises halting or shutting down the equipment.

Illustration 49. The method of any preceding or subsequent illustrations or combination of illustrations, wherein implementing the safety response comprises generating an alert notification on a remote device.

Illustration 50. The method of any preceding or subsequent illustrations or combination of illustrations, further comprising controlling the safety control response based on a detected proximity of the person to equipment while the person is within the control zone.

Illustration 51. A non-transitory computer readable storage medium comprising a plurality of instructions executable by one or more processors, which, when executed on the one or more processors, cause the one or more processors to perform actions including: receiving visual data from at least one camera having a field of view of at least a portion of a drilling site; identifying a control zone of the portion of the drilling site within the field of view; identifying a person in the field of view; responsive to identifying the person, determining whether the person is the control zone; and responsive to determining the person is in the control zone, implementing a safety control response and maintaining the safety control response until the person exits the control zone.

Illustration 52. The non-transitory computer readable storage medium of any preceding or subsequent illustrations or combination of illustrations, wherein the instructions for implementing the safety control response comprise instructions for activating an alarm.

Illustration 53, The non-transitory computer readable storage medium of any preceding or subsequent illustrations or combination of illustrations, wherein the instructions for implementing the safety control response comprise instructions for controlling equipment of the drilling site.

Illustration 54. The non-transitory computer readable storage medium of any preceding of subsequent illustrations or combination of illustrations, wherein the instructions for controlling equipment comprise instructions for halting or shutting down the equipment.

Illustration 55. The non-transitory computer readable storage medium of any preceding or subsequent illustrations or combination of illustrations, wherein the instructions for implementing the safety control response comprise instructions for generating an alert notification on a remote device.

Illustration 56. The non-transitory computer readable storage medium of any preceding or subsequent illustrations or combination of illustrations, wherein the instructions further comprise instructions for controlling the safety control response based on a detected proximity of the person to equipment while the person is within the control zone.

Illustration 57. A non-transitory computer readable storage medium comprising a plurality of instructions executable by one or more processors, which, when executed on the one or more processors, cause the one or more processors to perform actions according to any preceding claim.

As used herein, the terms “invention,” “the invention,” “this invention,” and “the present invention” are intended to refer broadly to all of the subject matter of this patent application and the claims below. Statements containing these terms should be understood not to limit the subject matter described herein or to limit the meaning or scope of the patent claims below.

As used herein, the meaning of “a,” “an,” and “the” includes singular and plural references unless the context clearly dictates otherwise.

The subject matter of embodiments of the present disclosure is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “vertical,” “horizontal,” “lateral,” “longitudinal,” “front,” and “back,” among others, are intended to refer to the orientation as illustrated and described in the figure (or figures) to which the components and directions are referencing.

The terms “comprising,” “having,” “including,” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention, and does not pose a limitation on the scope of the invention unless otherwise claimed. No language in the specification should be construed as indicating any non-claimed element as essential to the practice of the invention.

The above-described aspects are merely possible examples of implementations, merely set forth for a clear understanding of the principles of the present disclosure, Many variations and modifications can be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described embodiments, nor the claims that follow.

That which is claimed:

1. A system for improving safety for drilling operations, the system comprising:
at least one camera having a field of view of at least a portion of a drilling site;
a computer vision processor communicatively coupled to the camera, wherein the computer vision processor is configured to:
receive visual data from the camera;
identify a control zone of the portion of the drilling site within the field of view;
identify a person in the field of view based on a detection of a head and a body of the person;
responsive to identifying the person, determine whether the person is in the control zone; and
responsive to determining the person is in the control zone, implement a safety control response.

2. The system of claim 1, wherein the safety control response comprises an activation of an alarm, and wherein the alarm is an auditory alarm, a visual alarm, a text message, a voice message, a video message, an email, or a combination of some or all of the foregoing.

3. The system of claim 1, wherein the safety control response comprises a control of equipment of the drilling site.

4. The system of claim 3, wherein the control of equipment comprises halting or shutting down operation of the equipment.

5. The system of claim 1, wherein the safety control response comprises an alert notification on a device located remote from the drilling site.

6. The system of claim 1, wherein the processor is configured to maintain the safety control response until the person exits the control zone.

7. A method for drilling, the method comprising:
receiving, by a computer vision system, visual data from at least one camera having a field of view of at least a portion of a drilling site, wherein the portion of the drilling site comprises a portion of a pipe delivery system;
identifying, by the computer vision system, a control zone of the portion of the drilling site within the field of view;
identifying, by the computer vision system, a person in the field of view based on a detection of a head and a body of the person;
responsive to identifying the person, determining, by the computer vision system, whether the person is in the control zone; and
responsive to determining the person is in the control zone, implementing, by the computer vision system, a safety control response.

8. A system for drilling, the system comprising:
at least one camera having a field of view of at least a portion of a pipe delivery system at a drilling site;
a computer vision processor communicatively coupled to the camera, wherein the computer vision processor is configured to:
receive visual data from the camera;
identify a plurality of control zones of the portion of the pipe delivery system within the field of view and relative to at least one piece of equipment, the plurality of control zones comprising at least a first control zone and a second control zone;
identify a person in the field of view;
responsive to identifying the person, determine whether the person is in one of the plurality of control zones;
responsive to determining the person is in the first control zone, implement a first safety control response; and
responsive to determining the person is in the second control zone, implement a second safety control response different from the first safety control response.

9. The system of claim 8, wherein the first control zone is adjacent to the equipment and between the second control zone and the equipment.

10. The system of claim 8, wherein the first control zone is more proximate to the equipment than the second control zone is to the equipment.

11. The system of claim 8, wherein the first safety control response comprises a control of operation of the equipment or other associated equipment, and wherein the second safety control response comprises an activation of an alarm.

12. The system of claim 11, wherein the first safety control response comprises the activation of the alarm.

13. The system of claim 8, wherein the processor is configured to maintain the first safety control response while the person is in the first control zone and to maintain the second safety control response while the person is in the second control zone.

14. A method for drilling, the method comprising:
receiving, by a computer vision system, visual data from at least one camera having a field of view of at least a portion of a drilling site;
identifying, by the computer vision system, a plurality of control zones of the portion of the drilling site within the field of view and relative to at least one piece of equipment, the plurality of control zones comprising at least a first control zone and a second control zone;
identifying, by the computer vision system, a person in the field of view;
responsive, by the computer vision system, to identifying the person, determining whether the person is in one of the plurality of control zones;
responsive to determining the person is in the first control zone, implementing, by the computer vision system, a first safety control response; and
responsive to determining the person is in the second control zone, implementing, by the computer vision system, a second safety control response different from the first safety control response.

15. A computer vision system comprising:
at least one camera having a field of view of at least a portion of a drilling site;
a computer vision processor communicatively coupled to the camera, wherein the computer vision processor is configured to:
receive visual data from the camera;
identify a control zone of the portion of the drilling site within the field of view;
identify a person in the field of view;
responsive to identifying the person, determine whether the person is the control zone; and
responsive to determining the person is in the control zone, implement a safety control response and maintaining the safety control response until the person exits the control zone.

16. The computer vision system of claim 15, wherein the safety control response comprises an activation of an alarm.

17. The computer vision system of claim 15, wherein the safety control response comprises a control of equipment of the drilling site.

18. The computer vision system of claim 15, wherein the safety response comprises an alert notification on a remote device.

19. The computer vision system of claim 15, wherein the processor is configured to control the safety control response based on a detected proximity of the person to equipment while the person is within the control zone.

20. A method for drilling, the method comprising:
receiving visual data from at least one camera having a field of view of at least a portion of a drilling site;
identifying a control zone of the portion of the drilling site within the field of view;
identifying a person in the field of view;
responsive to identifying the person, determining whether the person is the control zone; and
responsive to determining the person is in the control zone, implementing a safety control response and maintaining the safety control response until the person exits the control zone.
